(19) United States
(12) Patent Application Publication
(10) Pub. No.: US 2026/0229978 A1
(43) Pub. Date: Aug. 6, 2026

(54) MOVER FOR DISPLACEMENT SYSTEMS AND METHODS AND SYSTEMS FOR FABRICATION AND USE OF SAME

(71) Applicant: PLANAR MOTOR INCORPORATED, Vancouver (CA)

(72) Inventors: Xiaodong LU, Vancouver (CA); Graham WILLIAMSON, Vancouver (CA); Scott PARKS, Boston, MA (US)

(21) Appl. No.: 19/147,807

(22) PCT Filed: Jan. 15, 2024
(86) PCT No.: PCT/CA2024/050037

§ 371 Date: Jul. 14, 2025

Related U.S. Application Data
(60) Provisional application No. 63/439,028, filed on Jan. 13, 2023.

(51) Int. Cl. H02K 41/03

(52) U.S. Cl. CPC H02K 41/031

(57) ABSTRACT

Aspects of the present disclosure provide methods, devices, and systems for manufacturing and using a mover in a displacement system. The mover may include an impermeable outer surface or shell. A method of manufacturing a mover may involve joining a first shell portion to a second shell portion along at least one side face of the mover with at least one actuation magnet between the first shell portion and the second shell portion. The at least one side face may be between a first surface of the mover and a second surface of the mover opposite the first surface. The at least one actuation magnet may be configured to generate forces for moving the mover in response to at least one external magnetic field.

### CROSS-REFERENCE TO RELATED APPLICATION

This application claims the benefit of and priority from U.S. provisional patent application No. 63/439,028, filed Jan. 13, 2023, the entire contents of which are incorporated by reference herein.

### FIELD

This disclosure relates generally to displacement systems or conveyors and movers for such systems.

### BACKGROUND

Displacement systems, or conveyors, such as XY tables and rotary tables may be used in various manufacturing, inspection, and assembling processes. These systems may include a stator and a moveable stage, typically referred to as a robotic device, mover device, or mover. The stator actuates the moveable stage. XY motion may be achieved by stacking two linear stages (e.g., a X-stage and a Y-stage) together via connecting bearings. Alternatively, a single moving stage capable of XY motion may be used, eliminating additional bearings. It may also be desirable for such a moving stage to be able to provide at least some Z motion.

Attempts have been made to design displacement devices using the interaction between current-carrying coils and permanent magnets. Examples include: U.S. Pat. Nos. 6,003,230; 6,097,114; 6,208,045; 6,441,514; 6,847,134; 6,987,335; 7,436,135; 7,948,122; US patent publication No. 2008/0203828; W. J. Kim and D. L. Trumper, High-precision magnetic levitation stage for photolithography. Precision Eng. 22 2 (1998 ), pp. 66-77; D. L. Trumper, et al, “Magnet arrays for synchronous machines”, IEEE Industry Applications Society Annual Meeting, vol. 1, pp. 9-18, 1993; and J. W. Jansen, C. M. M. van Lierop, E. A. Lomonova, A. J. A. Vandenput, “Magnetically Levitated Planar Actuator with Moving Magnets”, IEEE Tran. Ind. App., Vol 44, No 4, 2008.

More recent techniques for implementing displacement devices having a moveable stage and a stator are described in: PCT application No. PCT/CA2012/050751 (published under WO/2013/059934) entitled DISPLACEMENT DEVICES AND METHODS FOR FABRICATION, USE AND CONTROL OF SAME; PCT application No. PCT/CA2014/050739 (published under WO/2015/017933) entitled DISPLACEMENT DEVICES AND METHODS AND APPARATUS FOR DETECTING AND ESTIMATING MOTION ASSOCIATED WITH SAME; PCT application No. PCT/CA2015/050549 (published under WO/2015/188281) entitled DISPLACEMENT DEVICES, MOVEABLE STAGES FOR DISPLACEMENT DEVICES AND METHODS FOR FABRICATION, USE AND CONTROL OF SAME; PCT application No. PCT/CA2015/050523 (published under WO/2015/184553) entitled METHODS AND SYSTEMS FOR CONTROLLABLY MOVING MULTIPLE MOVEABLE STAGES IN A DISPLACEMENT DEVICE; and PCT application No. PCT/CA2015/050157 (published under WO/2015/179962) entitled DISPLACEMENT DEVICES AND METHODS FOR FABRICATION, USE AND CONTROL OF SAME.

However, existing displacement devices may lack certain functionality and performance. For example, existing devices may not be suitable for operation in adverse conditions, or may not be easily cleanable.

### SUMMARY

Embodiments of the present disclosure may provide methods, devices, and systems for manufacturing and using a mover which may include an impermeable outer surface or shell.

According to at least one embodiment, there is disclosed a method of manufacturing a mover operable to move in response to at least one external magnetic field, the method comprising: joining a first shell portion to a second shell portion along at least one side face of the mover with at least one actuation magnet between the first shell portion and the second shell portion, the at least one side face between a first surface of the mover and a second surface of the mover opposite the first surface, the at least one actuation magnet configured to generate forces for moving the mover in response to the at least one external magnetic field.

According to at least one embodiment, there is disclosed a mover operable to move in response to at least one external magnetic field, the mover comprising: a first surface; a second surface opposite the first surface; at least one side face between the first surface and the second surface; at least one actuation magnet, the at least one actuation magnet configured to generate forces for moving the mover in response to the at least one external magnetic field; and a first shell portion and a second shell portion, the first shell portion joined to the second shell portion along the at least one side face, the at least one actuation magnet between the first shell portion and the second shell portion.

According to at least one embodiment, there is disclosed a method of manufacturing a mover operable to move in response to at least one external magnetic field, the method comprising: joining a first shell portion to a second shell portion with at least one actuation magnet between the first shell portion and the second shell portion, the at least one actuation magnet configured to generate forces for moving the mover in response to the at least one external magnetic field, wherein at least a portion of a transition from an outer surface of the first shell portion to an outer surface of the second shell portion is smooth when the first shell portion has been joined to the second shell portion.

According to at least one embodiment, there is disclosed a mover operable to move in response to at least one external magnetic field, the mover comprising: at least one actuation magnet, the at least one actuation magnet configured to generate forces for moving the mover in response to the at least one external magnetic field; and a first shell portion and a second shell portion, the first shell portion joined to the second shell portion with the at least one actuation magnet between the first shell portion and the second shell portion, wherein at least a portion of a transition from an outer surface of the first shell portion to an outer surface of the second shell portion is smooth.

According to at least one embodiment, there is disclosed a method of manufacturing a mover operable to move in response to at least one external magnetic field, the method comprising: fixing a first shell portion and a second shell portion to at least one actuation magnet between the first shell portion and the second shell portion, the at least one actuation magnet configured to generate forces for moving the mover in response to the at least one external magnetic field; and joining the first shell portion to the second shell portion.

According to at least one embodiment, there is disclosed a mover operable to move in response to at least one external magnetic field, the mover comprising: at least one actuation magnet, the at least one actuation magnet configured to generate forces for moving the mover in response to the at least one external magnetic field; and a first shell portion and a second shell portion, the first shell portion joined to the second shell portion with the at least one actuation magnet between the first shell portion and the second shell portion, each of the first shell portion and the second shell portion fixed to the at least one actuation magnet.

Other aspects and features will become apparent to those ordinarily skilled in the art upon review of the following description of illustrative embodiments in conjunction with the accompanying figures.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a front section view of a displacement system according to one embodiment.

FIG. 2 is a partial front section view of a mover used in the displacement system of FIG. 1.

FIG. 3 is a front section view of another mover usable in the displacement system of FIG. 1, with mounting devices.

FIG. 4 is a front section view of another mover usable in the displacement system of FIG. 1, with pin-style mounting devices.

FIG. 5 is a front section view of another mover usable in the displacement system of FIG. 1, with threaded mounting holes and fasteners.

FIG. 6 is a front section view of a two-piece mover usable in the displacement system of FIG. 1.

FIG. 7 is a top view of an electronically controlled welding process for fabricating a mover according to another embodiment.

FIG. 8 is a front section view of the electronically controlled mover welding process of FIG. 7.

FIG. 9 is a perspective view of the electronically controlled mover welding process of FIG. 7.

FIG. 10 is a perspective view of an electronically controlled welding process for fabricating a mover according to another embodiment, with two stator operating areas.

### DETAILED DESCRIPTION

Manufacturing, assembly, and inspection systems may use displacement systems, or conveyors, to transport components to be processed, combined, and packaged. Electromagnetic planar motors may be used as displacement systems in such applications. An electromagnetic planar motor generally includes one or more movers for holding components and one or more stators for supporting and driving/actuating the movers. Movers having an impermeable outer surface or skin are described herein, along with systems for using such movers, and methods for manufacturing such movers.

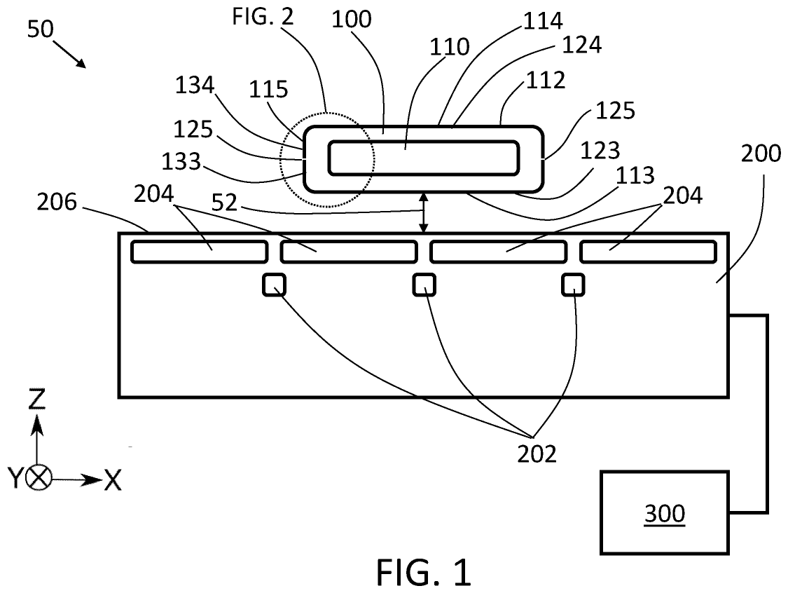

Referring to FIG. 1, a displacement system according to one embodiment is shown generally at 50 and includes a mover 100, a stator 200, and a controller 300. The mover 100 may be configured to carry one or more components (not shown). The mover 100 may also be referred to as a “mover device”, a “robotic device”, a “moveable stage”, a “motion stage”, or a “moveable motion stage”. Further, as used herein, the term “component” is a general term and non-limiting examples of components that may be carried by the mover 100 may include workpieces, products being assembled, raw parts, materials, samples, biological samples, drugs, payloads, devices, and assemblies. In the embodiment shown, the displacement system 50 includes only one mover 100. However, alternative embodiments may include multiple movers, and in some alternative embodiments, a plurality of movers may carry a holder which may hold one or more components. In some systems, all movers are substantially similar or nearly identical. However, other systems may include movers of varying sizes and configurations.

The stator 200 supports and actuates the mover 100, such that the mover 100 travels across the stator 200 to another location in displacement system 50. In the embodiment shown, the displacement system 50 includes only one stator 200. However, alternative embodiments may include multiple stators, and in some alternative embodiments, the multiple stators may be of different types—for example, in some alternative embodiments, some stators may have large work areas, while other stators may function as flyways between the work areas for rapid movement of movers and components in narrow spaces. This may be achieved by arranging a stator made from multiple electromagnetic driving regions, arranged in a single row in the direction of movement of the mover.

The controller 300 controls the stator 200 and the mover 100. The controller 300 may be directly connected to the stator 200 using a wired or wireless connection, and may control the mover 100 indirectly through the stator 200. Alternatively, the controller 300 may also be connected to the mover 100 using a wired or wireless connection, such that the controller 300 may communicate with the mover 100 directly. For example, a high speed data cable may be used, such as an ethernet cable, a HDMI cable, or any cable of sufficient data rate bandwidth. In some embodiments, the controller 300 may be completely integrated with the stator 200. In embodiments where the controller 300 is completely integrated within the stator 200, any method of electrical connection may be used, such as ribbon cables, edge board connectors, wire connectors, headers and pins, etc. A wireless connection may include Bluetooth, WiFi, Zigbee, Cellular, NFC, etc. In some embodiments, more than one controller may be used within the displacement system 50. For example, the controller 300 may only control the stator 200 or a group of stators including the stator 200, while another controller may control another stator or group of stators.

Generally, the mover 100 and the stator 200 may interact with each other via one or more magnetic fields, so that the stator 200 can provide forces and torques to the mover 100 to controllably move the mover 100. The controller 300 may determine and provide commands to the stator 200 to generate specific forces and torques to move the mover 100.

A pair of coordinate systems may be defined to help explain the movement of the mover 100 relative to the stator 200. In particular, a stator coordinate system may be defined, which is fixed to the stator 200. A mover coordinate system may also be defined, which is fixed to the mover 100 and moves with the mover 100 relative to the stator 200 and the stator coordinate system. Conventional Cartesian coordinates (x, y, z) may be used to describe these coordinate systems, although it will be appreciated that other coordinate systems could be used. For convenience and brevity, in the present description and the associated drawings, the directions (e.g., x, y, z directions) in the stator coordinate system and the directions in the mover coordinate system may be shown and described as being coincident with one another i.e., the stator-x (or Xs), stator-y (or Ys), and stator-z (or Zs) directions may be shown as coincident with mover-x (or Xm), mover-y (Ym), and mover-z (or Zm) directions, respectively. Accordingly, reference to directions x, y, and/or z may refer to directions in both or either of the stator and mover coordinate systems. However, it will be appreciated from the context herein that in some embodiments and/or circumstances, the mover 100 may move relative to the stator 200 such that these stator and mover coordinate systems are no longer coincident with one another. In such cases, the following convention may be adopted: the terms stator-x, stator-y and stator-z may be used to refer to directions and/or coordinates in the stator coordinate system and the terms mover-x, mover-y and mover-z may be used to refer to directions and/or coordinates in the mover coordinate system. The symbols Xm, Ym, and Zm may be used to refer respectively to the mover-x, mover-y and mover-z directions, the symbols Xs, Ys, and Zs may be used to refer respectively to the stator-x, stator-y and stator-z directions and the symbols X, Y, and Z may be used to refer respectively to either or both of the mover-x, mover-y, and mover-z and/or stator-x, stator-y, and stator-z directions. In some embodiments, during normal operation, the mover-z and stator-z directions are approximately in the same direction (e.g. within ±30° in some embodiments; within ±10° in some embodiments; and within ±2° in some embodiments).

The mover 100 includes an actuation magnet 110 and a shell 112 generally surrounding the actuation magnet 110. The actuation magnet 110 may also be referred to as a “magnet assembly”. In some embodiments, the actuation magnet 110 may include a plurality of smaller magnetization elements such as permanent magnets, each magnetization element having a magnetization direction. Examples of such actuation magnets are described and illustrated in U.S. Pat. No. 10,222,237 (incorporated herein by reference) as arrays of permanent magnets 112A, 112B, 112C, 112D (or collectively, magnet arrays 112). In the embodiment shown, the mover includes a single actuation magnet 110. However, in alternative embodiments, the mover 100 may include more than one actuation magnet, that is, the mover 100 may include a plurality of actuation magnets. The actuation magnet 110 is configured to respond to one or more external magnetic fields, and in particular is configured to generate forces for moving the mover 100 in response to one or more external magnetic fields.

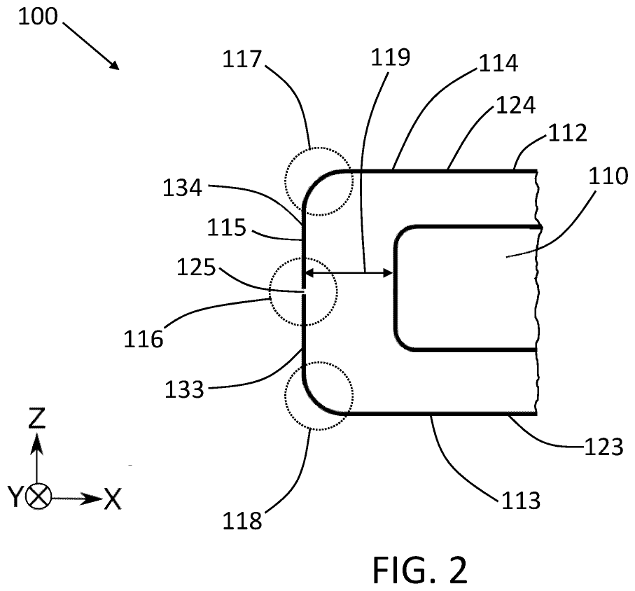

Referring now to FIGS. 1 and 2, the shell 112 includes a first shell portion 124 and a second shell portion 123, which are joined together at a joint 125. In the embodiment shown, the actuation magnet 110 is between the first shell portion 124 and the second shell portion 123. The first shell portion 124 includes a first surface 114 of the shell 112 and thus the mover 100, and the second shell portion 123 includes a second surface 113 of the shell 112 and thus the mover 100. The second surface 113 is opposite the first surface 114. The joint 125 between the first shell portion 124 and the second shell portion 123 is along a side face 115 of the mover 100 which extends between the first surface 114 and the second surface 113. More specifically, in the embodiment shown, the joint 125 is along a region of the side face 115 that is generally midway between the first surface 114 and second surface 113. However, in alternative embodiments, the joint 125 may be located in a different region of the side face 115, such as a region closer to the first surface 114 or a region closer to the second surface 113.

In the embodiment shown, the side face 115 is not parallel with the first surface 114 or the second surface 113; rather, the side face 115 is generally orthogonal to (i.e., forming a 90° angle with) the first surface 114 and the second surface 113. However, in alternative embodiments, the side face 115 may form other angles with the first surface 114 and/or the second surface 113, and in some alternative embodiments, the side face 115 may be parallel with the first surface 114 and/or the second surface 113.

As depicted in FIGS. 1 and 2, the first shell portion 124 is a top portion of the shell 112, the second shell portion 123 is a bottom portion of the shell 112, the first surface 114 is a top surface of the mover 100, the second surface 113 is a bottom surface of the mover 100, the side face 115 of the mover 100 is vertically between the first (top) surface 114 and the second (bottom) surface 113, and the joint 125 between the first (top) shell portion 124 and the second (bottom) shell portion is generally oriented horizontally. However, it should be understood that shell portions 123 and 124 and the joint 125 may be oriented differently-for example, the joint 125 may be generally vertically oriented, the first shell portion 124 is a left portion of the shell 112, and the second shell portion 123 may be a right portion of the shell. Furthermore, although in the embodiment shown the shell 112 includes two shell portions (i.e., the first shell portion 124 and the second shell portion 123), it will be appreciated that in alternative embodiments, the shell 112 may include more than two shell portions.

In the embodiment shown, a portion 134 of the first shell portion 124 extends from the first surface 114 along the side face 115 towards the second shell portion 123. Similarly, a portion 133 of the second shell portion 123 extends from the second surface 113 along the side face 115 towards the first shell portion 124. As a result, in the embodiment shown, the side face 115 overlaps with the first shell portion 124 and the second shell portion 123; that is, the first shell portion 124 and the second shell portion 123 each include respective portions of the side face 115. However, in alternative embodiments, the side face 115 may be spaced apart from the first shell portion 124 and/or the second shell portion 123. For example, the side face 115 may be located on one or more shell portions other than the first shell portion 124 or the second shell portion 123.Additionally, some alternative embodiments may include more than one side face 115 between the first surface 114 and the second surface 113. In some such embodiments, the joint 125 between the first shell portion 124 and the second shell portion 123 may be along more than one of the side faces.

The shell 112 generally forms and defines an outer surface of the mover 100. In the embodiment shown, when the first shell portion 124 and the second shell portion 134 have been joined to form the shell 112, substantially all or all of the shell 112, and thus of the outer surface of the mover 100, is smooth. That is, the shell 112 is generally devoid of any sharp projections, edges, or indentations. In particular, when the first shell portion 124 and the second shell portion 134 have been joined to form the shell 112, a transition 116 from an outer surface of the first shell portion 124 to an outer surface of the second shell portion 123 is smooth, a transition 117 from the first surface 114 to the side face 115 is smooth, and a transition 118 from the second surface 113 to the side face 115 is smooth. More specifically, in the embodiment shown, the transition 116 is generally flat, while the transitions 117 and 118 are curved. That is, at the transition 116, each portion of the outer surface of the first shell portion 124 is collinear with a respective adjacent portion of the outer surface of the second shell portion 123. Conversely, the transition 117 curves with a first radius of curvature, while the transition 118 curves with a second radius of curvature. The first radius of curvature and the second radius of curvature may have values greater than 2 mm, greater than 3 mm, greater than 5 mm, greater than 10 mm, or greater than 30 mm, for example.

Although in the embodiment shown substantially all or all of the shell 112 is smooth (e.g., flat or curved), alternative embodiments may differ. For example, in some alternative embodiments, one or more of the transitions 116, 117, and 118 may not be smooth over the entire transition, or may not be smooth at all. That is, with respect to each of the transitions 116, 117, and 118, in some embodiments, substantially all or all of the transition may be smooth, while in other embodiments, only a portion of the transition may be smooth, and in yet other embodiments, no part of the transition may be smooth. Thus, as an example, with respect to the transition 116, in some embodiments, at substantially all or all of the transition 116, each portion of the outer surface of the first shell portion 124 may be collinear with a respective adjacent portion of the outer surface of the second shell portion 123, while in other embodiments, portions of the outer surface of the first shell portion 124 at the transition 116 may only be collinear with respective adjacent portions of the outer surface of the second shell portion 123 the transition 116 over a portion of the transition 116, and in yet other embodiments, no portion of the outer surface of the first shell portion 124 at the transition 116 may be collinear with a respective adjacent portion of the outer surface of the second shell portion 123 the transition 116. Similarly, with respect to the transition 117, in some embodiments, substantially all or all of the transition 117 may curve with the first radius of curvature, while in other embodiments, only a portion of the transition 117 may curve with the first radius of curvature, and in yet other embodiments, no part of the transition 117 may curve with the first radius of curvature. Likewise, with respect to the transition 118, in some embodiments, substantially all or all of the transition 118 may curve with the second radius of curvature, while in other embodiments, only a portion of the transition 118 may curve with the second radius of curvature, and in yet other embodiments, no part of the transition 118 may curve with the second radius of curvature.

Furthermore, although in the embodiment shown the transition 116 is generally flat, in alternative embodiments the transition 116 may instead curve with a joint radius of curvature. As noted above, in some embodiments, substantially all or all of the transition 116 may be smooth, while in other embodiments, only a portion of the transition 116 may be smooth, and in yet other embodiments, no part of the transition 116 may be smooth. Thus, in some embodiments where the transition 116 curves with the joint radius of curvature, substantially all or all of the transition 116 may curve with the joint radius of curvature, while in other embodiments, only a portion of the transition 116 may curve with the joint radius of curvature. The joint radius of curvature may have a value greater than 2 mm, greater than 3 mm, greater than 4 mm, greater than 5 mm, greater than 6 mm, greater than 30 mm, greater than 50 mm, or greater than 100 mm, for example.

Generally, in the embodiment shown, substantially all or all of the shell 112 and thus the outer surface of the mover 100 is convex when the first shell portion 124 and the second shell portion 134 have been joined to form the shell 112. However, in alternative embodiments, at least a portion of the shell 112 may not be convex.

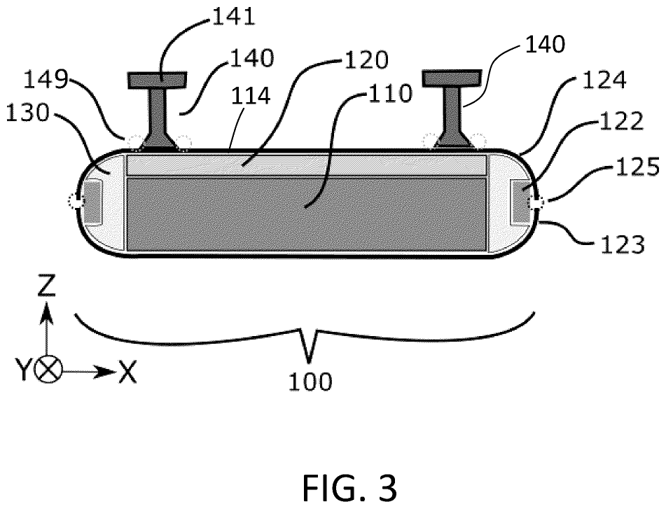

Referring to FIG. 2, in the mover 100 of the embodiment shown, the actuation magnet 110 is spaced apart from the side face 115 of the mover 100 by a gap 119. However, alternative embodiments may differ. For example, in some alternative embodiments, the actuation magnet 110 may be in contact with the side face 115. In other alternative embodiments, the actuation magnet 110 may be separated from the side face 115 by one or more structures between the actuation magnet 110 and the side face 115. For example, in some such embodiments, the mover 100 may include a backing support, such as backing support 122 depicted in FIGS. 3 to 5 and 8 below, between the actuation magnet 110 and the side face 115. As described further below, the backing support may be configured to support the side face 115 at least during joining of the first shell portion 124 to the second shell portion 123. The backing support may also be configured to thermally isolate the actuation magnet 110 from the side face 115 at least during joining of the first shell portion 124 to the second shell portion 123, particularly in embodiments where the first shell portion 124 is joined to the second shell portion 123 using a welding process. In some embodiments, the backing support may include a metal. In some embodiments, the backing support may be joined to the first shell portion 124 and/or the second shell portion 123 prior to joining the first shell portion 124 to the second shell portion 123.

Referring back to FIG. 1, The stator 200 includes sensors 202 and coils 204. Each of the sensors 202 is configured to measure at least one magnetic field. Each of the sensors 202 may only accurately measure a magnetic field within a certain range that sensor 202. Examples of such sensors are described and illustrated in U.S. Pat. No. 10,222,237 as magnetic field sensors 501. The sensors 202 may include, for example, Hall-effect magnetic field sensors, magneto-resistive sensors, and/or other suitable types of magnetic field sensors that can measure magnetic flux density. In FIG. 1, the stator 200 is shown as including three sensors 202; however, it will be appreciated that in some embodiments, the stator 200 may include only one sensor 202, or two sensors 202, or more than three sensors 202. These sensors 202 may also be arranged at positions extending along the Y direction in addition to different X positions that are shown in FIG. 1.

Each of the coils 204 is configured to generate at least one external magnetic field. Examples of such coils 210 are described and illustrated in U.S. Pat. No. 10,222,237 as coil traces 126. In FIG. 1, the stator 200 is shown as including four coils 204; however, it will be appreciated that in some embodiments, the stator 200 may include only one coil 204, two coils 204, three coils 204, or more than four coils 204. In some embodiments, the stator 200 may include a plurality of coils distributed in one or more planar layers. In some embodiments, the layout of the coils 204 may include a first group of coils that are linearly elongated in a first direction. The first group of coils may also include a second coil pitch in a second direction. The coils 204 may also include a second group of coils that are linearly elongated in a second direction. The second group of coils may also include a first coil pitch in the first direction. The first and second coil pitch may be equal. In some embodiments, the coils 204 may be linearly elongated in different directions (i.e., linearly elongated in X direction or linearly elongated in Y direction) and may vertically overlap with other coils.

The sensors 202 and coils 204 may be arranged in a pattern on the stator 200, for example as described and illustrated in U.S. Pat. No. 10,222,237. Patterns may include one or more sensors 202 configured around each of the coils 204, such as one of the sensors 202 at each edge of one of the coils 204. Other patterns may also be possible. It will be appreciated that the sensors 202 may be arranged in patterns near or around the coils 204 to provide proper feedback to the controller 300 for position sensing and control of the mover 100, for example. In some embodiments, the stator 200 may further include a plurality of iron teeth (not shown).

The stator 200 includes a working surface 206 for the mover 100 to move upon. Generally, the working surface 206 describes a continuous area upon which the mover 100 may be controlled by the stator 200. Suitable feedback control algorithms executed by the controller 300 and suitable position feedback from the sensors 202 allow the controller 300 and the stator 200 to move and control the mover 100. The working surface 206 may be flat, curved, cylindrical, spherical or some other shape that allows the mover 100 to move along the working surface 206. In some embodiments, a combined working surface may be defined by a plurality of stators, such that each working surface of each stator may be combined into a larger combined working surface. While the working surface 206 is depicted horizontally in FIG. 1, it should be understood that the working surface 206 can be mounted vertically or at an angle to gravity.

The mover 100 may move along the working surface 206 in a “contact mode” or a “non-contact mode”. The contact mode (also known as “sitting mode”) may involve contact media such as sliding and/or rolling bearings. The non-contact mode (also known as “levitation mode”) may require maintaining a controllable gap 52 between the mover 100 and the working surface 206 of the stator 200 in a normal direction Z. The gap 52 may be an air gap. The mover 100 may also rest upon the working surface 206 without moving, which may be in a contact mode or a non-contact mode. In the non-contact mode, the mover 100 may have six degrees-of-freedom (6-DOF) controllable motion (known as “active levitation mode”). Alternatively, the mover 100 may maintain the gap 52 by passive levitation means (known as “passive levitation mode”). In the passive levitation mode, the mover 100 may rest above the working surface 206 in the non-contact mode.

In some embodiments described herein, one or more amplifiers (not shown) may be connected to the coils 204. The amplifiers may drive one or more electrical currents in the coils 204, generating one or more external magnetic fields. The controller 300 may be connected to deliver control signals to the one or more amplifiers. The control signals may be used to control current driven by the one or more amplifiers into the coils 204. The current controllably driven into each of the coils 204 may cause that coil 204 to create or generate at least one external magnetic field. The at least one external magnetic field thus generated causes corresponding magnetic forces to act on the mover 100. The one or more external magnetic fields may act on the actuation magnet 110, thereby moving the mover 100 relative to the stator 200, such as across the working surface 206. The mover 100 may be controllable in at least two in-plane degrees-of-freedom (2-DOF) motions, including but not limited to three in-plane degrees-of-freedom (3-DOF) controllable motions and 6-DOF controllable motions. In general, embodiments such as those described herein may involve one or more mover devices that are controllably movable relative to a stator or a working surface in at least 2 in-plane DOF motions, in 3 in-plane DOF motions, in 4 in-plane DOF motions, in 5 in-plane DOF motions, or in 6-DOF controllable motions, for example.

In some embodiments, the magnetic forces associated with the interactions between the magnetic fields created by the currents in the coils 204 and the magnetic fields associated with the actuation magnet 110 may attract the mover 100 toward the stator 200 at all times when a controller is controlling the currents driven by one or more amplifiers. In other embodiments, the magnetic forces associated with the interactions between the magnetic fields created by the currents in the coils 204 and the magnetic fields associated with the actuation magnet 110 may force the mover 100 away from the stator 200 to balance gravitational forces with the gap 52 at all times.

In some embodiments, the gap 52 between the mover 100 and the stator 200 may be maintained by air bearings or compressed-fluid bearings. It will be appreciated that in some embodiments, the gap 52 may be zero, such as when the mover 100 operates in contact mode. Contact mode may involve contact media such as sliding and/or rolling bearings between mover device 100 and working surface 202.

As described above, the mover 100 may work in “levitation mode”, being levitated near the working surface 206 of the stator 200 without contacting the stator 200. In levitation mode, the mover 100 may move along the stator 200 working surface 206 in X and Y directions, where X and Y are two non-parallel (e.g., orthogonal) directions inside the working surface 206. It will be appreciated that the gap 52 between the working surface 206 and the mover 100 second (i.e., bottom) surface 113 is generally much smaller than the mover's lateral dimensions (i.e., dimensions in the X and Y directions).

Although the mover 100 may be capable of 6-DOF controllable motion, such functionality may not be necessary in all situations. In certain embodiments, levitation of the mover 100 may not be needed and heavy load carrying capability of the mover 100 may be desirable. In such embodiments, the mover 100 may sit on the working surface 206 supported with mechanical bearings (for example, planar sliding bearings and/or ball transfer units), and may be capable of in-plane 3-DOF controllable motion: translation in X and Y and rotation around Z, where X and Y are two non-parallel (e.g., orthogonal) directions in working surface 206 and Z is a direction normal to the working surface 206. When the mover 100 relies on sliding and/or rolling bearings for support on the working surface 206 and the mover 100 is capable of 3-DOF controllable motion, it may be referred to as working in “3-DOF controlled sitting mode”.

In some embodiments, the mover 100 may be capable of in-plane 3-DOF controllable motions (translations in X and Y and rotation around Z) working in levitation mode without contact with working surface 206. In this mode, the translation in Z, rotation around X, and rotation around Y (and thus the associated degrees-of-freedom) of the mover 100 may be open-loop controlled without feedback, using suitable passive levitation technology. When the mover 100 is capable of 3-DOF controllable motion without contact with the stator 200, it may be referred to as working in “3-DOF controlled levitation mode”.

FIGS. 3 to 6 depict various non-limiting embodiments of the mover 100 of FIGS. 1 and 2. As depicted in each of FIGS. 3 to 6, and as described above, the mover 100 includes the actuation magnet 110 and the shell 112, and the shell 112 includes the first shell portion 124 and the second shell portion 123 joined at the joint 125.

Referring now to FIG. 3, a particular non-limiting embodiment of the mover 100 of FIGS. 1 and 2 is shown and additionally includes a structural frame 120, a backing support 122, a structural filler piece 130, and mounting devices 140. The structural frame 120 is bonded to the actuation magnet 110. In some embodiments, the structural frame 120 may optionally be used to mount additional mounting or locating features not shown. The backing support 122 is positioned at the joint 125 between the first and second shell portions 124 and 123. The backing support 122 may be, for example, a backing ring. The structural filler piece 130 supports the first and second shell portions 124 and 123 and the backing support 122 from an interior of the shell 112 of the mover 100. Generally, the actuation magnet 110, the structural frame 120, the backing support 122, and the structural filler piece 130 may collectively be referred to as an interior assembly of the mover 100.

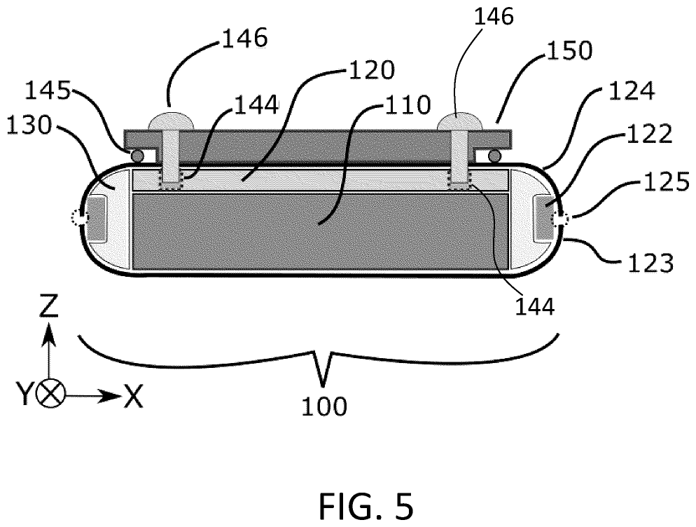

In the embodiment of FIG. 3, the mounting devices 140 protrude from the first (top) surface 114 and may be affixed to the first shell portion 124 directly. In the embodiment shown, each mounting device 140 includes a horizontal protrusion 141. To mount to tooling (such as tooling 150 as depicted in FIG. 5) or directly to a product or component (not shown), the horizontal protrusions 141 may be inserted into the tooling or product/component. In some embodiments, while inserted into the tooling or product/component, the mounting devices 140 may be gripped by the tooling/product/component, or the tooling/product/component may insert into an interlock feature (i.e., a keyway; not shown) and, using a lateral motion (typically utilizing friction or spring loaded features to stably hold the secured position), to reach a location where the horizontal protrusions 141 prevent vertical motion from removing the tooling/product/component.

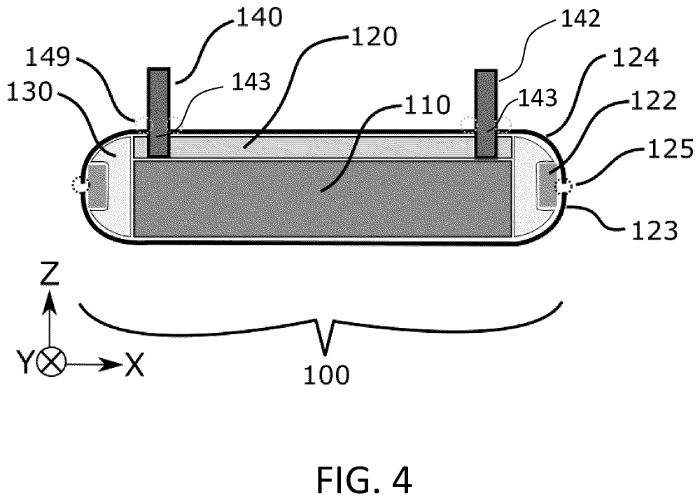

Referring now to FIG. 4, another particular non-limiting embodiment of the mover 100 of FIGS. 1 and 2 is shown and additionally includes pin-style mounting components 142 fixed to the interior assembly of the mover 100. The mounting components 142 penetrate through the first shell portion 124 and may be fixed to the structural frame 120. The mounting components 142 protrude through appropriate cutouts 143 in the first shell portion 124. The cutouts 143 allow the mounting devices 142 to access the interior assembly of the mover 100 (for structural mounting and positioning of the mounting device 140 location) as well as exterior environment (to interact with components for mounting purposes). As in the embodiment shown in FIG. 3, the mounting components 140 may generally be configured for interacting with tooling (such as tooling 150 as depicted in FIG. 5) or directly with a product or component (not shown). In some embodiments, an interior of the mover 100 may be permanently sealed at the cutouts 143, for example by welding around the perimeter of each cutout 143. Locating features of the mounting components 142 may be used to interact with mating features in tooling or products/components to constrain a position of the respective tooling/product/component. Such interactions may be combined with one or more holding forces (such as gravity or magnetic forces) to securely hold the tooling/product/component during operation of the mover 100. In some embodiments, the mounting devices may be round dowels that interact with holes or slots in a tooling/product/component.

Referring now to FIG. 5, another particular non-limiting embodiment of the mover 100 of FIGS. 1 and 2 is shown and additionally includes mounting holes 144, a replaceable seal 145, and tooling 150. The mounting holes 144 are used by fasteners 146 to fasten the tooling 150 to the first surface 114 of the mover 100. For example, in some embodiments, the mounting holes 144 and the fasteners 146 may include respective complementary threading, such that the fasteners 146 can be threaded into the mounting holes 144. The replaceable seal 145 is positioned between the tooling 145 and the first surface 114 such that it surrounds all of the mounting holes 144. The replaceable seal may be, for example, a gasket or an O-ring. In several industrial applications, threads may create difficult to clean areas that are unacceptable if exposed to an external environment. In the embodiment of FIG. 5, the mounting holes 144 and fasteners 146 may be used to mount the tooling 150 for a particular application, while the replaceable seal 145 maintains a cleanability of the mover 100. Provided that the tooling 150 is left installed, the cleanability of the mover 100 can be maintained. However, if at anytime the tooling 150 is removed from the mover 100, then when the tooling 150 is re-installed onto the mover 100, the mover 100 may require a complete cleaning or sterilization prior to being used again.

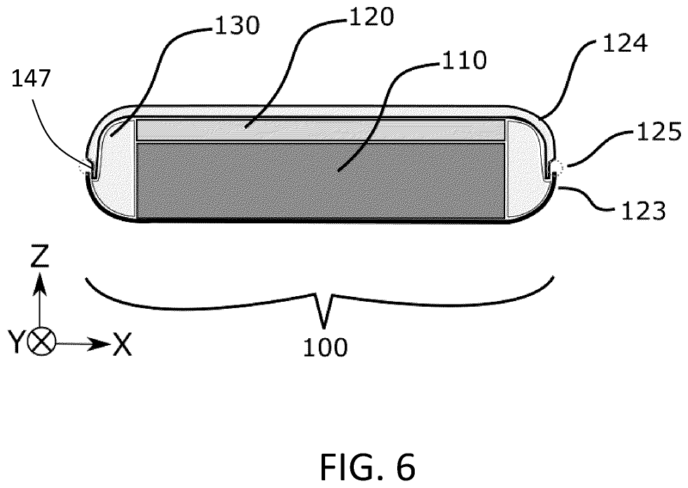

Referring now to FIG. 6, another particular non-limiting embodiment of the mover 100 of FIGS. 1 and 2 is shown and additionally features an overlap region 147 at the joint 125, where the first shell portion 124 overlaps with the second shell portion 123 when the first shell portion 124 is joined to the second shell portion 123. During joining of the first shell portion 124 to the second shell portion 123 (discussed further below), the overlap region 147 may act as a backing or support to protect an interior of the mover 100 from undesirable effects of the joining process (e.g., heat affected zones during welding processes). In the embodiment shown in FIG. 6, a thicker first shell portion 124 may be used to achieve adequate protection for the interior of the mover. Additional protection of the interior assembly may also be achieved with use of localized separation between the first shell portion 124 and the structural filler piece 130, and/or with use of reflective layers between the first shell portion 124 and the structural filler piece 130. In some embodiments, the first shell portion 124 may include an internally bent lip to form the overlap region 147 with the second shell portion 123. In some embodiments, the first shell portion 124 may be locally thinned at the joint 125 to create a suitable location for joining processes such as welding.

Generally, in each mover 100 of the embodiments shown in FIGS. 1 to 6, it may be desirable to keep the first shell portion 124 and the second shell portion 123 as thin as possible to minimize weight and maximize the mover's payload capacity during levitation or other movement. However, as discussed further below, joining portions of a shell that are too thin may be difficult, particularly when the joining is done using processes such as welding. As such, appropriate selection of a thickness for each of the first and second shell portions 124 and 123 may be important. In the movers 100 of the embodiments shown in FIGS. 1 to 6, the first and second shell portions 124 and 123 may be at least 0.2 mm thick, may be at most 1 mm thick, and/or may be at most 0.5 mm thick. Further, in some embodiments, each of the first and second shell portions 124 and 123 may have a generally uniform thickness. In some embodiments, a thickness of the first shell portion 124 may be generally equal to a thickness of the second shell portion 123.

In the movers 100 of the embodiments of FIGS. 1 to 6, the first shell portion 124, the second shell portion 123, and the backing support 122 may include or be made up of stainless steel and/or one or more non-magnetic or low-magnetic shell materials. Low-magnetic shell materials may include, for example, materials having a magnetic permeability less than 1, a magnetic permeability less than 3, a magnetic permeability less than 5, or a magnetic permeability less than 10. Use of non-magnetic or low-magnetic shell/backing support materials may reduce or eliminate unwanted distortions of magnetic fields of the mover 100 which may negatively affect a performance of the mover 100.

Generally, to manufacture the mover 100, the first shell portion 124 is joined to the second shell portion 123 at the joint 125 with the actuation magnet 110 positioned between the first shell portion 124 and the second shell portion 123. In some embodiments, the joining of first shell portion 124 to the second shell portion 123 may occur along the side face 115 of the mover. In some embodiments, the joining of first shell portion 124 to the second shell portion 123 may result at least a portion of the transition 116 being smooth, or substantially all or all of the transition 116 being smooth. In some embodiments, the first shell portion 124 may be joined directly to the second shell portion 123. However, in other embodiments, the first shell portion 124 may be joined to the second shell portion 123 through one or more other structures. In some embodiments, the first shell portion 124 and the second shell portion 123 may be fixed to the actuation magnet 110 before joining the first shell portion 124 to the second shell portion 123. In other embodiments, prior to joining the first shell portion 124 to the second shell portion 123, the first shell portion 124 and the second shell portion 123 may be fixed to one or more parts of the interior assembly, such as the structural frame. In some embodiments where the first shell portion 124 and the second shell portion 123 are first fixed to the actuation magnet 110 of the interior assembly, joining of the first shell portion 124 to the second shell portion 123 may involve causing at least one external magnetic field to control a position and an orientation of the mover 100 during the joining process. For example, the at least one external magnetic field may cause the mover 100 to levitate during the joining process. In such embodiments, the joining process may occur over the working surface 206 of the stator 200, and the controller 300 may be used to control the at least one external magnetic field.

In some embodiments, joining of the first shell portion 124 and the second shell portion 123 may effectively seal the actuation magnet 110 in an interior of the mover 100. Movers of such embodiments may be used, for example, in hygienic applications, and may be referred to as “hygienic movers”. In some embodiments, joining of the joint 125 for the first shell portion 124 and the second shell portion 123 may be carried out in a vacuum or low pressure environment. Thus, in some embodiments, an interior of the mover 100 may include a vacuum or low pressure environment when the first shell portion 124 has been joined to the second shell portion 123. In some embodiments, joining of the first shell portion 124 and the second shell portion 123 may be carried out with one or more welding processes, such as with one or more laser welding processes. Although any welding method may be used to join the first shell portion 124 and the second shell portion 123, it should be understood that laser welding has some particular advantages due to being impervious to the magnetic field of the mover.

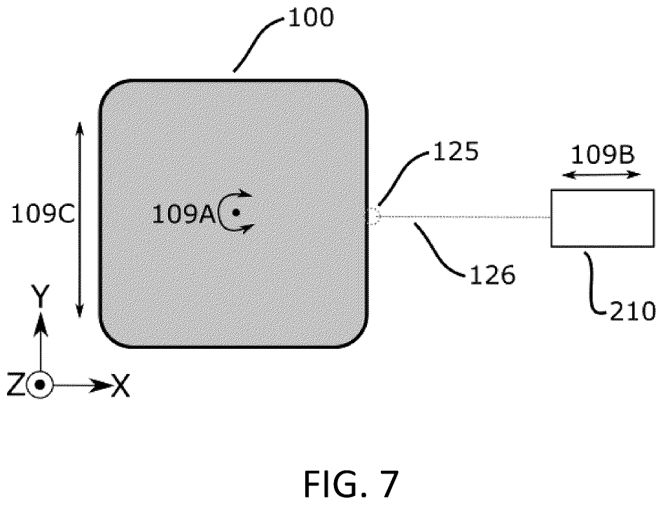

FIGS. 7 to 10 depict controlled mover welding process for joining the first shell portion 124 to the second shell portion 123 according to one embodiment. To join two shell portions of the mover 100, a welding source 210 transmits welding energy beam 126 to the joint 125. Generally, when the term “welding source” is used to describe a welding system or device carrying out the welding process, it should be understood that it may be only an emitting portion of the overall welding system or device which is moved during the welding process. In embodiments where welding is used to join the first and second shells 124 and 123, the joint 125 may also be referred to as the “weld location” or “weld seam”. During the welding process, one or more relative controlled motions 109 occur between the welding source 210 and the mover 100. The controlled motions 109 may include relative mover rotation 109A, relative mover motion along the welding source direction 109B, and relative lateral mover motion 109C with respect to beam 126 direction. The controlled motions may be controlled together to allow the welding source 210 to weld a section of the joint 125 between the first and second shell portions 124 and 123. A source of the relative motion between the mover 100 and welding source 210 may include the mover 100 being actuated by an external magnetic field generated by the coils 204 of the stator 200, external actuators, or some combination of both. By rotating the mover 100 about the vertical axis (rotation 109A), it is possible to access all sides of the mover 100 for welding the joint 125. When mover rotation 109A is combined with movement along the welding source direction 109B, it is possible to maintain an ideal distance between the welding source 210 and the joint 125 while welding the joint along multiple sides of the mover 100, including the corners. Maintaining such an ideal distance may be important, as some welding methods may be sensitive to this separation distance. Furthermore, by combining mover rotation 109A and movement along the welding source direction 109B with lateral motion 109C, it is possible to maintain a desired welding angle of the mover 100 (e.g., orthogonal to the joint 125) while welding along multiple sides of the mover 100, including the corners.

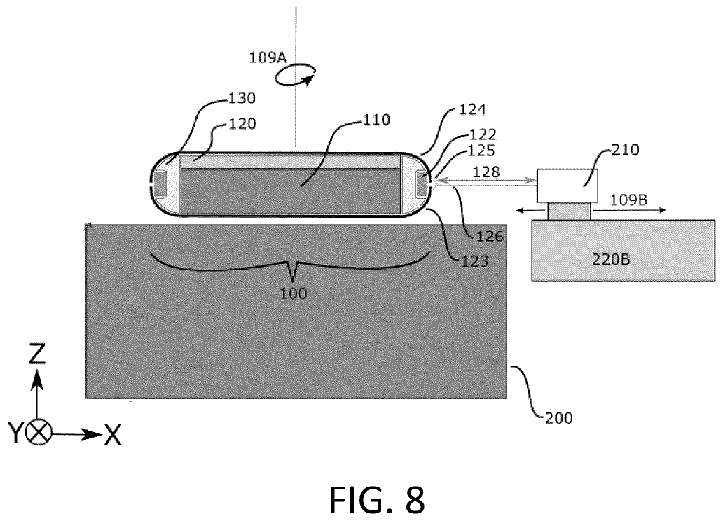

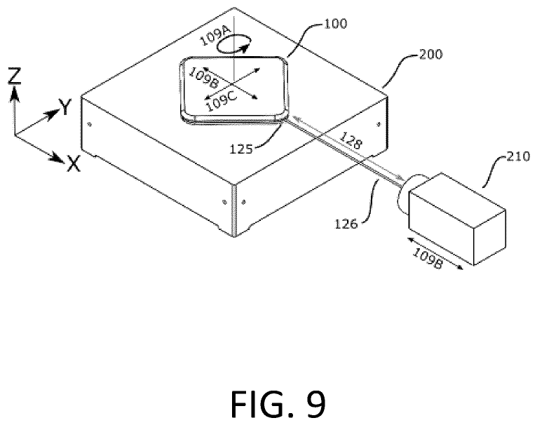

FIGS. 8 and 9 depict a particular embodiment of the process generally shown in FIG. 7. In this embodiment, the stator 200 is used to levitate the mover 100 to a desired height and rotate the mover about the vertical axis 109A (other rotation or horizontal motions of the mover 100 on the stator 200 may also be used to facilitate the welding), and an external actuator 220B is used to drive the welding source towards or away from the mover. As noted above, for many welding methods, maintaining a consistent welding distance 128 between the joint 125 and the welding source 210 is required to achieve good welding results.

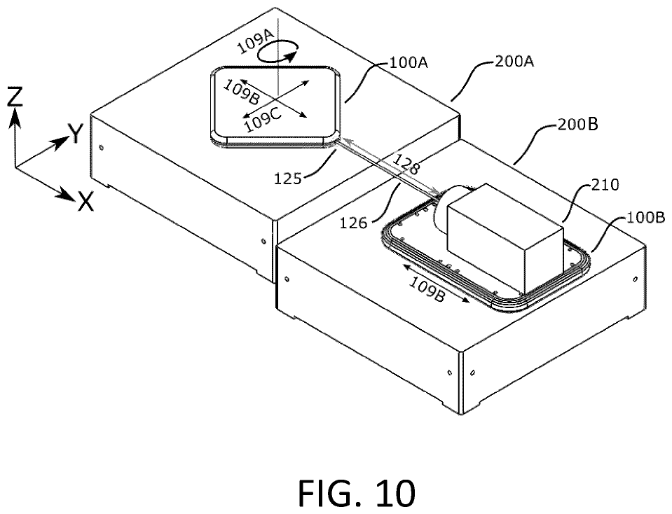

FIG. 10 depicts another particular embodiment of the process generally shown in FIG. 7. In this embodiment, a first stator 200A is used to control a mover 100A which is to be welded, and a second stator 200B is used to control a second mover 100B which carries the welding source 210. To generate required relative motion for the welding operation in this embodiment, either the first mover 100A may be controlled by the first stator 200A, the second mover 100B (and thus the welding source 210) may be controlled by the second stator 200B, or both the first mover 100A and the second mover 100B may be controlled by the first stator 200A and the second stator 200B, respectively. While levitating, each of the movers may be operated with up to 6 degrees of freedom motion. During the welding process, in many cases the welding distance 128 (between the welding source 210 and the joint 125) will be maintained at a specific optimal spacing to control the weld process. Although in the embodiment shown in FIG. 10 the stators cannot cross between the first stator 200A and second stator 200B due to a height difference, it should be understood that the welding source 210 could be mounted to the second mover 100B in a manner that would allow the first mover 100A and the second mover 100B to circulate on both stators 200A and 200B. For example, working surfaces of the first and second stators 200A and 200B could generally be coincident.

In some embodiments where a stator is used to control a mover during the welding process (such as the stator 200 being used to control the mover 100), it may be possible to arrange a sequence of movers for welding, where after welding is completed on one mover a different mover may be controlled via the stator to go to the welding position. With a suitably large operating area to queue movers for welding, it may possible to weld multiple movers without replacing the movers after every weld is completed.

Although in some embodiments the welding source 210 may operate in a continuous welding state for large sections of the welding seam, it should be understood that in other embodiments welding sources may utilize discrete or pulsed operation for welding, and in yet other embodiments an indexed motion of the mover relative to the welding source may also be used. Additionally, the welding process may utilize filler material as required to fill voids and create a large enough weld bead at the joint 125. For controlled welding processes such as those of the embodiments of FIGS. 7 to 10, it should be understood that a suitable filler material dispenser (e.g., a wire feeder) may be utilized and controlled to add the material to the joint 125 (i.e., the weld location). Additionally, the filler material may be added to the weld at a regulated rate controlled by the dispenser to match the welding rate. If a filler material is used to weld the first and second shell portions 124 and 123 together, the resulting weld bead may be ground away after welding, leaving a smooth transition 116 for maximum cleanability.

In the embodiments shown in FIGS. 7-10, a welding area (i.e., the joint 125) is on the side face 115 of the mover 100, and generally at or around the mid-section of the mover vertically. Although this arrangement is not required, it can provide benefits for both welding and respective post-weld processing. By situating the welding area on the side face 115, if the weld ultimately protrudes slightly after welding (which may occur, for example, if filler is used), it will be contacted first in a post-welding grinding process, thereby making it easier to avoid grinding other portions of the shell 112. Additionally, the welding joint should generally be kept consistent along its length by avoiding sharp outer corners. In some embodiments, the first shell portion 124 and the second shell portion 123 may be formed with a stamping operation to achieve a curved bend along the entire perimeter of each shell portion.

In some embodiments, prior to welding the first shell portion 124 to the second shell portion 123, the interior assembly may be constructed by combining one or more of the actuation magnet 110, the structural frame 120, the structural filler piece 130, and the backing support 122. To seal the first and second shell portions 124 and 123 around the interior assembly, the shell portions should first be bonded on their interior surfaces to the interior assembly to prevent separation during the life of the mover 100. Once suitably affixed to the interior assembly, the first and second shell portions 124 and 123 may then be welded at the joint 125, and during welding a filler material may be used (e.g., wire) to fill any gaps between the first and second shell portions 124 and 123. The filler material should be compatible with the materials of both shell portions.

As noted above, joining processes such as welding may introduce difficulties when joining the first and second shell portions 124 and 123 if the shell portions are too thin. These difficulties include avoiding melting the parts on an interior of the mover, creating a strong weld joint that is well supported from the interior, the small mass being welded making it difficult to control the melt pool, and avoiding over and under melting. Additional difficulties may arise where, due to manufacturing variabilities, the joint 125 includes a variable gap between the first and second shell portions 124 and 123 when they are positioned for joining, as a gap in a butt joint can be more difficult to weld. With the use of the backing support 122 positioned along the joint 125 of the mover 100, it may be possible to increase the strength of the weld, provide good weld support (e.g., against internal buckling), isolate the other internal components of the mover from the heat of the welding process, and allow a variable gap between the first and second shell portions 124 and 123 to be sealed more easily (either by welding both the first and second shell portions 124 and 123 to the backing support 122 respectively or utilizing a filling material to bridge the gap potentially creating a welded joint between all three parts). Thus, in embodiments which include the backing support 122, during welding, the backing support 122 can support the weld area (i.e., the side face 115 at the joint 125), provide a larger thermal mass area to protect the rest of the interior assembly of the mover from a weld heat affected zone, act as a protective buffer for welding processes that may penetrate the first second shell portion 124 and/or the second shell portions 123 during welding, and, if welded or otherwise fixed or joined to one or both of the first and second shell portions 124 and 123, provide additional stiffness at the weld area.

In some embodiments, when the first and second shell portions 124 and 123 are completely welded together, the mover 100 will have a complete protective layer (i.e., the shell 112) isolating its interior parts from external environments, and may thus be considered a hygienic mover. In such embodiments, the complete protective layer may also be easily cleaned.

In some embodiments, during fabrication of the mover 100, one or both of the mounting devices 140 and the mounting components 142 may be fixed to first surface 114 of the mover 100 or to one or more parts of the interior assembly (e.g., the structural frame 120), for example, using welding or adhesives/bonding. In embodiments where the mounting devices 140/mounting components 142 penetrate the first surface 114, each mounting device 140/mounting component 142 may be sealed along its perimeter 149 to prevent the formation of a crevice that could store contaminants. For example, such sealing may be done using a welding process. Similarly, in some embodiments, the mounting holes 144 and fasteners 146 may be used to affix the tooling 150 to the mover 100.

### Clauses

This disclosure includes but is not limited to the following clauses, which may be combined with other subject matter in this specification.

1. A robotic system comprising:
one or more stators with a first stator forming a working surface extending in a first direction and a second direction nonparallel with the first direction, each stator comprising a plurality of sensor elements and a plurality of coils; and
at least one mover comprising one or more magnetic components interacting with currents driven into coils in the plurality of stators to controllably move along the working surface in at least two in-plane DOF and comprising shell layers with at least two portions,
wherein the shell layers have a top portion and bottom portion and are welded together along the side faces of the mover.

2. The system of clause 1, wherein there is a backing ring located at the welding area on the interior side of the shell.

3. The system of clause 1 or 2, wherein the top shell or bottom shell is bonded to at least a portion of the interior mover assembly.

4 The system of clause 3, wherein the backing ring is welded to either of the top shell or bottom shell.

5. The system of any one of clauses 1 to 4, wherein the top shell or bottom shell have an outer surface radius greater than 1 mm.

6. The system of any one of clauses 1 to 5 wherein the top and bottom shell overlap horizontally along at least a portion of the welding area.

7. The system of any one of clauses 1 to 6, wherein the weld location between the top and bottom shells is generally near the middle region of the mover vertically.

8. The system of any one of clauses 1 to 7, wherein the backing ring is substantially thicker than either the top shell or bottom shell

9. The system of any one of clauses 1 to 8, wherein the top shell and bottom shell are comprised of stainless steel.

10. The system of any one of clauses 1 to 9, wherein the bottom shell is made of a generally non-magnetic material.

11. The system of any one of clauses 1 to 10, wherein the bottom shell is made of an austenitic stainless steel.

12. The system of any of one clauses 1 to 11 where the mover has one or more mounting devices for securing or locating a tooling or a product.

13. The system of clause 12, wherein the mounting device is sealed around the perimeter of its interface with the mover.

14. The system of clause 13, wherein the sealing is done with welding.

15. The system of clause 13, wherein the sealing is done with a gasket or O-ring.

16. The system of any one of clauses 12 to 15, wherein the mounting device comprises a threaded feature.

17. The system of any one of clauses 12 to 16, wherein the mounting device comprises vertically extending locating features.

18. The system of clause 17, wherein the mounting device additionally comprises horizontally extending features.

19. The system of any one of clauses 1 to 18, wherein the mover is controlled electronically to move in coordination with the welder's operation to weld at least a portion of the weld seam.

20. The system of clause 19, wherein the controlled motion of the mover relative to the welding source comprises rotation with respect to the mover's vertical axis.

21. The system of clause 19 or 20, wherein the controlled motion of the mover relative to the welding source comprises movement towards or away from the welding source along the welding source direction.

22. The system of any one of clauses 19 to 21, wherein the controlled motion of the mover relative to the welding source comprises lateral movement relative to the welding source direction.

23. The system of any one of clauses 19 to 22, wherein a stator is used to actuate the mover in at least a portion of the controlled motion of the mover relative to the welding source.

24. The system of any one of clauses 19 to 23, wherein an external actuator is used to generate at least a portion of the controlled motion of the mover relative to the welding source.

25. The system of any one of clauses 1 to 24, wherein a laser welder is used to weld the seam between the top shell and bottom shell.

26. The system of any one of clauses 19 to 25, wherein a second mover is used to control the position and orientation of the welding source.

27 The system of any one of clauses 19 to 26, wherein the welding distance is controlled during welding of the mover.

28. A method of manufacturing a mover operable to move in response to at least one external magnetic field, the method comprising:
joining a first shell portion to a second shell portion along at least one side face of the mover with at least one actuation magnet between the first shell portion and the second shell portion, the at least one side face between a first surface of the mover and a second surface of the mover opposite the first surface, the at least one actuation magnet configured to generate forces for moving the mover in response to the at least one external magnetic field.

29. The method of clause 28 wherein the at least one side face is spaced apart from the first shell portion and the second shell portion.

30. The method of clause 28 or 29 wherein the at least one side face is not parallel with the first surface.

31. The method of clause 30 wherein the at least one side face is generally orthogonal to the first surface.

32. The method of any one of clauses 28 to 31 wherein the at least one side face is not parallel with the second surface.

33. The method of clause 32 wherein the at least one side face is generally orthogonal to the second surface.

34. The method of any one of clauses 28 to 33 wherein the first shell portion comprises the first surface.

35. The method of clause 34 wherein a portion of the first shell portion extends from the first surface along the at least one side face towards the second shell portion.

36. The method of clause 35 wherein at least a portion of a transition from the first surface to the at least one side face is smooth.

37. The method of clause 36 wherein substantially all or all of the transition from the first surface to the at least one side face is smooth.

38. The method of clause 36 or 37 wherein the at least a portion of the transition from the first surface to the at least one side face curves with a first radius of curvature greater than 2 mm.

39. The method of clause 36 or 37 wherein substantially all or all of the transition from the first surface to the at least one side face curves with a first radius of curvature greater than 2 mm.

40. The method of clause 38 or 39 wherein the first radius of curvature is greater than 3 mm.

41. The method of clause 38, 39, or 40 wherein the first radius of curvature is greater than 5 mm.

42. The method of any one of clauses 38 to 41 wherein the first radius of curvature is greater than 10 mm.

43. The method of any one of clauses 38 to 42 wherein the first radius of curvature is greater than 30 mm.

44. The method of any one of clauses 28 to 43 wherein the second shell portion comprises the second surface.

45. The method of clause 44 wherein a portion of the second shell portion extends from the second surface along the at least one side face towards the first shell portion.

46. The method of clause 45 wherein at least a portion of a transition from the second surface to the at least one side face is smooth.

47. The method of clause 46 wherein substantially all or all of the transition from the second surface to the at least one side face is smooth.

48. The method of clause 46 or 47 wherein the at least a portion of the transition from the second surface to the at least one side face curves with a second radius of curvature greater than 2 mm.

49. The method of clause 46 or 47 wherein substantially all or all of the transition from the second surface to the at least one side face curves with a second radius of curvature greater than 2 mm.

50. The method of clause 48 or 49 wherein the second radius of curvature is greater than 3 mm.

51. The method of clause 48, 49, or 50 wherein the second radius of curvature is greater than 5 mm.

52. The method of any one of clauses 21 to 51 wherein the second radius of curvature is greater than 10 mm.

53. The method of any one of clauses 21 to 52 wherein the second radius of curvature is greater than 30 mm.

54. The method of any one of clauses 28 to 53 wherein joining the first shell portion to the second shell portion comprises joining the first shell portion to the second shell portion with the at least one actuation magnet spaced apart from the at least one side face.

55. The method of clause 54 wherein joining the first shell portion to the second shell portion comprises joining the first shell portion to the second shell portion with a backing support between the at least one actuation magnet and the at least one side face, the backing support configured to support the at least one side face at least during joining of the first shell portion to the second shell portion.

56. The method of clause 55 wherein the backing support is further configured to thermally isolate the at least one actuation magnet from the at least one side face at least during joining of the first shell portion to the second shell portion.

57. The method of clause 55 or 56 where in the backing support comprises a metal.

58. The method of clause 55, 56, or 57 further comprising joining the backing support to the first shell portion before joining the first shell portion to the second shell portion.

59. The method of any one of clauses 55 to 58 further comprising joining the backing support to the second shell portion before joining the first shell portion to the second shell portion.

60. The method of any one of clauses 28 to 59 wherein the first shell portion is a top shell portion of the mover, the second shell portion is a bottom shell portion of the mover, and the at least one side face is vertically between the first surface and the second surface.

61. The method of clause 60 wherein the mover is operable to move in response to at least one external magnetic field below the bottom shell portion of the mover.

62. The method of any one of clauses 28 to 61 wherein joining the first shell portion to the second shell portion along the at least one side face comprises joining the first shell portion to the second shell portion along a region of the at least one side face generally midway between the first surface and the second surface.

63. The method of any one of clauses 28 to 62 wherein at least a portion of a transition from an outer surface of the first shell portion to an outer surface of the second shell portion is smooth when the first shell portion has been joined to the second shell portion.

64. A method of manufacturing a mover operable to move in response to at least one external magnetic field, the method comprising:
joining a first shell portion to a second shell portion with at least one actuation magnet between the first shell portion and the second shell portion, the at least one actuation magnet configured to generate forces for moving the mover in response to the at least one external magnetic field,
wherein at least a portion of a transition from an outer surface of the first shell portion to an outer surface of the second shell portion is smooth when the first shell portion has been joined to the second shell portion.

65. The method of clause 63 or 64 wherein substantially all or all of the transition from the outer surface of the first shell portion to the outer surface of the second shell portion is smooth when the first shell portion has been joined to the second shell portion.

66. The method of clause 63, 64, or 65 wherein substantially all or all of an outer surface of the mover is smooth when the first shell portion has been joined to the second shell portion.

67. The method of clause 66 wherein substantially all or all of the outer surface of the mover is convex when the first shell portion has been joined to the second shell portion.

68. The method of clause 63, 64, or 65 wherein substantially all or all of an outer surface of the mover is convex when the first shell portion has been joined to the second shell portion

69. The method of any one of clauses 63 to 68 wherein the at least a portion of the transition from the outer surface of the first shell portion to the outer surface of the second shell portion curves with a joint radius of curvature greater than 2 mm when the first shell portion has been joined to the second shell portion.

70. The method of any one of clauses 63 to 68 wherein substantially all or all of the transition from the outer surface of the first shell portion to the outer surface of the second shell portion curves with a joint radius of curvature greater than 2 mm when the first shell portion has been joined to the second shell portion.

71. The method of clause 69 or 70 wherein the joint radius of curvature is greater than 3 mm.

72. The method of clause 69, 70, or 71 wherein the joint radius of curvature is greater than 4 mm.

73. The method of any one of clauses 69 to 72 wherein the joint radius of curvature is greater than 5 mm.

74. The method of any one of clauses 69 to 73 wherein the joint radius of curvature is greater than 6 mm.

75. The method of any one of clauses 69 to 74 wherein the joint radius of curvature is greater than 30 mm.

76. The method of any one of clauses 69 to 75 wherein the joint radius of curvature is greater than 50 mm.

77. The method of any one of clauses 69 to 76 wherein the joint radius of curvature is greater than 100 mm.

78. The method of any one of clauses 63 to 68 wherein when the first shell portion has been joined to the second shell portion, at the at least a portion of the transition from the outer surface of the first shell portion to the outer surface of the second shell portion, each portion of the outer surface of the first shell portion is collinear with a respective adjacent portion of the outer surface of the second shell portion.

79. The method of any one of clauses 63 to 68 or of clause 78 wherein when the first shell portion has been joined to the second shell portion, at substantially all or all of the transition from the outer surface of the first shell portion to the outer surface of the second shell portion, each portion of the outer surface of the first shell portion is collinear with a respective adjacent portion of the outer surface of the second shell portion.

80. The method of any one of clauses 28 to 79 wherein the first shell portion is at least 0.2 mm thick.

81. The method of any one of clauses 28 to 80 wherein the first shell portion is at most 1 mm thick.

82. The method of any one of clauses 28 to 81 wherein the first shell portion is at most 0.5 mm thick.

83. The method of any one of clauses 28 to 82 wherein the first shell portion has a generally uniform thickness.

84. The method of any one of clauses 28 to 83 wherein the second shell portion is at least 0.2 mm thick.

85. The method of any one of clauses 28 to 84 wherein the second shell portion is at most 1 mm thick.

86. The method of any one of clauses 28 to 85 wherein the second shell portion is at most 0.5 mm thick.

87. The method of any one of clauses 28 to 86 wherein the second shell portion has a generally uniform thickness.

88. The method of any one of clauses 28 to 87 wherein a thickness of the first shell portion is generally equal to a thickness of the second shell portion.

89. The method of any one of clauses 28 to 88 wherein the first shell portion comprises stainless steel.

90. The method of any one of clauses 28 to 89 wherein the first shell portion comprises a non-magnetic material.

91. The method of any one of clauses 28 to 90 wherein the first shell portion comprises a low-magnetic shell material.

92. The method of any one of clauses 28 to 91 wherein the second shell portion comprises stainless steel.

93. The method of any one of clauses 28 to 92 wherein the second shell portion comprises a non-magnetic shell material.

94. The method of any one of clauses 28 to 93 wherein the second shell portion comprises a low-magnetic shell material.

95. The method of any one of clauses 28 to 94 wherein joining the first shell portion to the second shell portion comprises joining the first shell portion directly to the second shell portion.

96. The method of any one of clauses 28 to 95 wherein joining the first shell portion to the second shell portion comprises joining the first shell portion to the second shell portion in a vacuum.

97. The method of any one of clauses 28 to 96 wherein joining the first shell portion to the second shell portion comprises welding the first shell portion to the second shell portion.

98. The method of clause 97 wherein welding the first shell portion to the second shell portion comprises laser welding the first shell portion to the second shell portion.

99. The method of any one of clauses 28 to 98 wherein joining the first shell portion to the second shell portion comprises sealing the at least one actuation magnet in an interior of the mover.

100. The method of clause 99 wherein the interior comprises a vacuum.

101. The method of any one of clauses 28 to 100 further comprising fixing at least one mounting fastener to the mover, the at least one mounting fastener configured to secure a tooling, a component, or a product to the mover.

102. The method of clause 101, wherein fixing the at least one mounting fastener to the mover comprises fixing the at least one mounting fastener to the first shell portion.

103. The method of clause 101 or 102, wherein fixing the at least one mounting fastener to the mover comprises fixing the at least one mounting fastener to the second shell portion.

104. The method of any one of clauses 28 to 103 wherein the mover is operable to move in two in-plane degrees-of-freedom in response to at least one external magnetic field.

105. The method of clause 104 wherein the mover is operable to move in two in-plane degrees-of-freedom relative to a working surface of a stator in response to at least one external magnetic field.

106. The method of any one of clauses 28 to 105 wherein the mover is operable to move in six degrees-of-freedom in response to at least one external magnetic field.

107. The method of any one of clauses 28 to 106 further comprising fixing the first shell portion and the second shell portion to the at least one actuation magnet before joining the first shell portion to the second shell portion.

108. A method of manufacturing a mover operable to move in response to at least one external magnetic field, the method comprising:
fixing a first shell portion and a second shell portion to at least one actuation magnet between the first shell portion and the second shell portion, the at least one actuation magnet configured to generate forces for moving the mover in response to the at least one external magnetic field; and
joining the first shell portion to the second shell portion.

109. The method of clause 107 or 108 further comprising causing at least one external magnetic field to control a position and an orientation of the mover at least when joining the first shell portion to the second shell portion.

110. The method of clause 109 wherein causing the at least one external magnetic field to control the position and the orientation of the mover comprises causing the at least one external magnetic field to levitate the mover.

111. The method of any one of clauses 28 to 110 further comprising forming the first shell portion with a stamping process.

112. The method of any one of clauses 28 to 111 further comprising forming the second shell portion with a stamping process.

113. A mover manufactured by the method of any one of clauses 28 to 112.

114. A mover operable to move in response to at least one external magnetic field, the mover comprising:
a first surface;
a second surface opposite the first surface;
at least one side face between the first surface and the second surface;
at least one actuation magnet, the at least one actuation magnet configured to generate forces for moving the mover in response to the at least one external magnetic field; and
a first shell portion and a second shell portion, the first shell portion joined to the second shell portion along the at least one side face, the at least one actuation magnet between the first shell portion and the second shell portion.

115. The mover of clause 114 wherein the at least one side face is spaced apart from the first shell portion and the second shell portion.

116. The mover of clause 114 or 115 wherein the at least one side face is not parallel with the first surface.

117. The mover of clause 116 wherein the at least one side face is generally orthogonal to the first surface.

118. The mover of any one of clauses 114 to 117 wherein the at least one side face is not parallel with the second surface.

119. The mover of clause 118 wherein the at least one side face is generally orthogonal to the second surface.

120. The mover of any one of clauses 114 to 119 wherein the first shell portion comprises the first surface.

121. The mover of clause 120 wherein a portion of the first shell portion extends from the first surface along the at least one side face towards the second shell portion.

122. The mover of clause 121 wherein at least a portion of a transition from the first surface to the at least one side face is smooth.

123. The mover of clause 122 wherein substantially all or all of the transition from the first surface to the at least one side face is smooth.

124. The mover of clause 122 or 123 wherein the at least a portion of the transition from the first surface to the at least one side face curves with a first radius of curvature greater than 2 mm.

125. The mover of clause 122 or 123 wherein substantially all or all of the transition from the first surface to the at least one side face curves with a first radius of curvature greater than 2 mm.

126. The mover of clause 124 or 125 wherein the first radius of curvature is greater than 3 mm.

127. The mover of clause 124, 125, or 126 wherein the first radius of curvature is greater than 5 mm.

128. The mover of any one of clauses 124 to 127 wherein the first radius of curvature is greater than 10 mm.

129. The mover of any one of clauses 124 to 128 wherein the first radius of curvature is greater than 30 mm.

130. The mover of any one of clauses 114 to 129 wherein the second shell portion comprises the second surface.

131. The mover of clause 130 wherein a portion of the second shell portion extends from the second surface along the at least one side face towards the first shell portion.

132. The mover of clause 131 wherein at least a portion of a transition from the second surface to the at least one side face is smooth.

133. The mover of clause 132 wherein substantially all or all of the transition from the second surface to the at least one side face is smooth.

134. The mover of clause 132 or 133 wherein the at least a portion of the transition from the second surface to the at least one side face curves with a second radius of curvature greater than 2 mm.

135. The mover of clause 132 or 133 wherein substantially all or all of the transition from the second surface to the at least one side face curves with a second radius of curvature greater than 2 mm.

136. The mover of clause 134 or 135 wherein the second radius of curvature is greater than 3 mm.

137. The mover of clause 134, 135, or 136 wherein the second radius of curvature is greater than 5 mm.

138. The mover of any one of clauses 134 to 137 wherein the second radius of curvature is greater than 10 mm.

139. The mover of any one of clauses 134 to 138 wherein the second radius of curvature is greater than 30 mm.

140. The mover of any one of clauses 114 to 139 wherein the at least one actuation magnet is spaced apart from the at least one side face.

141. The mover of clause 140 further comprising a backing support between the at least one actuation magnet and the at least one side face, the backing support configured to support the at least one side face at least during joining of the first shell portion to the second shell portion.

142. The mover of clause 141 wherein the backing support is further configured to thermally isolate the at least one actuation magnet from the at least one side face at least during joining of the first shell portion to the second shell portion.

143. The mover of clause 141 or 142 wherein the backing support comprises a metal.

144. The mover of clause 141, 142, or 143 wherein the backing support is joined to the first shell portion.

145. The mover of any one of clauses 141 to 144 wherein the backing support is joined to the second shell portion.

146. The mover of any one of clauses 114 to 145 wherein the first shell portion is a top shell portion of the mover, the second shell portion is a bottom shell portion of the mover, and the at least one side face is vertically between the first surface and the second surface.

147. The mover of clause 146 wherein the mover is operable to move in response to at least one external magnetic field below the bottom shell portion of the mover.

148. The mover of any one of clauses 114 to 147 wherein the first shell portion is joined to the second shell portion along a region of the at least one side face generally midway between the first surface and the second surface.

149. The mover of any one of clauses 114 to 148 wherein at least a portion of a transition from an outer surface of the first shell portion to an outer surface of the second shell portion is smooth.

150. A mover operable to move in response to at least one external magnetic field, the mover comprising:
at least one actuation magnet, the at least one actuation magnet configured to generate forces for moving the mover in response to the at least one external magnetic field; and
a first shell portion and a second shell portion, the first shell portion joined to the second shell portion with the at least one actuation magnet between the first shell portion and the second shell portion,
wherein at least a portion of a transition from an outer surface of the first shell portion to an outer surface of the second shell portion is smooth.

151. The mover of clause 149 or 150 wherein substantially all or all of the transition from the outer surface of the first shell portion to the outer surface of the second shell portion is smooth.

152. The mover of clause 149, 150, or 151 wherein substantially all or all of an outer surface of the mover is smooth.

153. The mover of clause 152 wherein substantially all or all of the outer surface of the mover is convex.

154. The mover of clause 149, 150, or 151 wherein substantially all or all of an outer surface of the mover is convex.

155. The mover of any one of clauses 149 to 154 wherein the at least a portion of the transition from the outer surface of the first shell portion to the outer surface of the second shell portion curves with a joint radius of curvature greater than 2 mm.

156. The mover of any one of clauses 149 to 154 wherein substantially all or all of the transition from the outer surface of the first shell portion to the outer surface of the second shell portion curves with a joint radius of curvature greater than 2 mm.

157. The mover of clause 155 or 156 wherein the joint radius of curvature is greater than 3 mm.

158. The mover of clause 155, 156, or 157 wherein the joint radius of curvature is greater than 4 mm.

159. The mover of any one of clauses 155 to 158 wherein the joint radius of curvature is greater than 5 mm.

160. The mover of any one of clauses 155 to 159 wherein the joint radius of curvature is greater than 6 mm.

161. The mover of any one of clauses 155 to 160 wherein the joint radius of curvature is greater than 30 mm.

162. The mover of any one of clauses 155 to 161 wherein the joint radius of curvature is greater than 50 mm.

163. The mover of any one of clauses 155 to 162 wherein the joint radius of curvature is greater than 100 mm.

164. The mover of any one of clauses 149 to 154 wherein at the at least a portion of the transition from the outer surface of the first shell portion to the outer surface of the second shell portion, each portion of the outer surface of the first shell portion is collinear with a respective adjacent portion of the outer surface of the second shell portion.

165. The mover of any one of clauses 149 to 154 or of clause 164 wherein at substantially all or all of the transition from the outer surface of the first shell portion to the outer surface of the second shell portion, each portion of the outer surface of the first shell portion is collinear with a respective adjacent portion of the outer surface of the second shell portion.

166. The mover of any one of clauses 114 to 165 wherein the first shell portion is at least 0.2 mm thick.

167. The mover of any one of clauses 114 to 166 wherein the first shell portion is at most 1 mm thick.

168. The mover of any one of clauses 114 to 167 wherein the first shell portion is at most 0.5 mm thick.

169. The mover of any one of clauses 114 to 168 wherein the first shell portion has a generally uniform thickness.

170. The mover of any one of clauses 114 to 169 wherein the second shell portion is at least 0.2 mm thick.

171. The mover of any one of clauses 114 to 170 wherein the second shell portion is at most 1 mm thick.

172. The mover of any one of clauses 114 to 171 wherein the second shell portion is at most 0.5 mm thick.

173. The mover of any one of clauses 114 to 172 wherein the second shell portion has a generally uniform thickness.

174. The mover of any one of clauses 114 to 173 wherein a thickness of the first shell portion is generally equal to a thickness of the second shell portion.

175. The mover of any one of clauses 114 to 174 wherein the first shell portion comprises stainless steel.

176. The mover of any one of clauses 114 to 175 wherein the first shell portion comprises a non-magnetic shell material.

177. The mover of any one of clauses 114 to 176 wherein the first shell portion comprises a low-magnetic shell material.

178. The mover of any one of clauses 114 to 177 wherein the second shell portion comprises stainless steel.

179. The mover of any one of clauses 114 to 178 wherein the second shell portion comprises a non-magnetic shell material.

180. The mover of any one of clauses 114 to 179 wherein the second shell portion comprises a low-magnetic shell material.

181. The mover of any one of clauses 114 to 180 wherein the first shell portion is joined directly to the second shell portion.

182. The mover of any one of clauses 114 to 181 wherein the first shell portion is welded to the second shell portion.

183. The mover of clause 182 wherein the first shell portion is laser welded to the second shell portion.

184. The mover of any one of clauses 114 to 183 the at least one actuation magnet is sealed in an interior of the mover by the first shell portion and the second shell portion.

185. The mover of clause 184 wherein the interior comprises a vacuum.

186. The mover of any one of clauses 114 to 185 further comprising at least one mounting fastener, the at least one mounting fastener configured to secure a tooling, a component, or a product to the mover.

187. The mover of clause 186, wherein the at least one mounting fastener is fixed to the first shell portion.

188. The mover of clause 186 or 187, wherein the at least one mounting fastener is fixed to the second shell portion.

189. The mover of any one of clauses 114 to 188 wherein the mover is operable to move in two in-plane degrees-of-freedom in response to at least one external magnetic field.

190. The mover of clause 189 wherein the mover is operable to move in two in-plane degrees-of-freedom relative to a working surface of a stator in response to at least one external magnetic field.

191. The mover of any one of clauses 114 to 190 wherein the mover is operable to move in six degrees-of-freedom in response to at least one external magnetic field.

192. The mover of any one of clauses 114 to 191 wherein the first shell portion and the second shell portion are fixed to the at least one actuation magnet.

193. A mover operable to move in response to at least one external magnetic field, the mover comprising:
at least one actuation magnet, the at least one actuation magnet configured to generate forces for moving the mover in response to the at least one external magnetic field; and
a first shell portion and a second shell portion, the first shell portion joined to the second shell portion with the at least one actuation magnet between the first shell portion and the second shell portion, each of the first shell portion and the second shell portion fixed to the at least one actuation magnet.

194. A displacement system comprising:
a mover according to any one of clauses 113 to 193;
at least one stator comprising at least one coil positioned to generate the at least one external magnetic field.

195. The displacement system of clause 194, further comprising a controller configured to control the stator to generate the at least one external magnetic field.

Although specific embodiments have been described and illustrated, such embodiments should be considered illustrative only and not as limiting the invention as construed according to the accompanying claims.

1. (canceled)

2. A mover operable to move in response to at least one external magnetic field, the mover comprising:
a first surface;
a second surface opposite the first surface;
at least one side face between the first surface and the second surface;
at least one actuation magnet, the at least one actuation magnet configured to generate forces for moving the mover in response to the at least one external magnetic field; and
a first shell portion and a second shell portion, the first shell portion welded to the second shell portion along the at least one side face, the at least one actuation magnet between the first shell portion and the second shell portion.

3. The mover of claim 2 wherein the first shell portion comprises the first surface.

4. The mover of claim 3 wherein a portion of the first shell portion extends from the first surface along the at least one side face towards the second shell portion.

5. The mover of claim 4 wherein at least a portion of a transition from the first surface to the at least one side face is smooth.

6. The mover of claim 5 wherein the at least a portion of the transition from the first surface to the at least one side face curves with a first radius of curvature greater than 2 mm.

7. The mover of claim 2 wherein the second shell portion comprises the second surface.

8. The mover of claim 7 wherein a portion of the second shell portion extends from the second surface along the at least one side face towards the first shell portion.

9. The mover of claim 8 wherein at least a portion of a transition from the second surface to the at least one side face is smooth.

10. The mover of claim 9 wherein the at least a portion of the transition from the second surface to the at least one side face curves with a second radius of curvature greater than 2 mm.

11. The mover of claim 2 wherein the at least one actuation magnet is spaced apart from the at least one side face.

12. The mover of claim 2 wherein at least a portion of a transition from an outer surface of the first shell portion to an outer surface of the second shell portion is smooth.

13. The mover of claim 12 wherein substantially all or all of the transition from the outer surface of the first shell portion to the outer surface of the second shell portion is smooth.

14. The mover of claim 13 wherein substantially all or all of an outer surface of the mover is smooth.

15. The mover of claim 12 wherein the at least a portion of the transition from the outer surface of the first shell portion to the outer surface of the second shell portion curves with a joint radius of curvature greater than 2 mm.

16. The mover of claim 2 wherein the first shell portion and the second shell portion are fixed to the at least one actuation magnet.

17. (canceled)

18. (canceled)

19. A method of manufacturing a mover operable to move in response to at least one external magnetic field, the method comprising:
fixing a first shell portion and a second shell portion to at least one actuation magnet between the first shell portion and the second shell portion, the at least one actuation magnet configured to generate forces for moving the mover in response to the at least one external magnetic field; and
joining the first shell portion to the second shell portion.

20. (canceled)

21. The mover of claim 2 wherein the first shell portion comprises an overlap region along at least a portion of the at least one side face, the overlap region between a portion of the second shell portion and the at least one actuation magnet.

22. The mover of claim 2 further comprising a backing support between the at least one actuation magnet and the at least one side face, wherein:
the backing support is joined to the first shell portion, the second shell portion, or both the first shell portion and the second shell portion, and
the backing support is configured to support the at least one side face at least during welding of the first shell portion to the second shell portion.

23. The mover of claim 2 wherein the first shell portion comprises stainless steel and the second shell portion comprises stainless steel.

24. The mover of claim 2 wherein the first shell portion is laser welded to the second shell portion.

25. The method of claim 19 wherein joining the first shell portion to the second shell portion comprises welding the first shell portion to the second shell portion.

26. The method of claim 25 wherein welding the first shell portion to the second shell portion comprises laser welding the first shell portion to the second shell portion.
